(19) United States
(12) Patent Application Publication
(10) Pub. No.: US 2025/0377581 A1
(43) Pub. Date: Dec. 11, 2025

(54) IMAGING APPARATUS

(71) Applicants: DENSO CORPORATION, Kariya-city (JP); KYOCERA Corporation, Fushimi-ku (JP)

(72) Inventors: Kanta OGAWA, Kariya-city (JP); Yasuki FURUTAKE, Kariya-city (JP); Taro OGURA, Kariya-city (JP); Yuta IWAI, Sagamihara-shi (JP); Atsushi KADOTA, Yokohama-shi (JP); Hiroyuki ABE, Yokohama-shi (JP)

(21) Appl. No.: 19/227,098

(22) Filed: Jun. 3, 2025

(30) Foreign Application Priority Data
Jun. 5, 2024 (JP) 2024-091676

(51) Int. Cl. G03B 17/12; G03B 30/00

(52) U.S. Cl. CPC G03B 17/12; G03B 30/00

(57) ABSTRACT

In an imaging apparatus, a holder includes a housing portion housing a lens, and a base portion extending in a direction orthogonal to an optical axis. A housing houses the base portion and an image sensor. A fixing member fixes the base portion and the housing. The fixing member includes a head portion that sandwiches the housing together with the base portion. A coefficient of linear expansion of the housing and a coefficient of linear expansion of the fixing member differ. A length in a direction of the optical axis from a portion of the base portion in contact with the housing to an end portion on a side opposite the portion in contact with the housing is longer than a length in the direction of the optical axis from a portion of the housing in contact with the head portion to a portion in contact with the base portion.

### CROSS-REFERENCE TO RELATED APPLICATION

This application is based on and claims the benefit of priority from Japanese Patent Application No. 2024-091676, filed on Jun. 5, 2024, the description of which is incorporated herein by reference.

### BACKGROUND

### Technical Field

The present disclosure relates to an imaging apparatus.

### Related Art

A camera apparatus that includes a camera case and a camera module has been known. In this camera apparatus, the camera case is fixed to a front windshield of a vehicle from inside a vehicle cabin. The camera module includes an optical unit and a camera board. The optical unit includes a lens. The camera board includes an image sensor and is fixed to an end portion of the optical unit. The camera module is fixed to the camera case.

### SUMMARY

An aspect of the present disclosure provides an imaging apparatus that includes a lens, a holder, an image sensor, a housing, and a fixing member. The holder includes a housing portion that houses the lens and a base portion that is connected to the housing portion and extends in a direction orthogonal to an optical axis of the lens. The image sensor outputs a signal corresponding to a captured image based on light passing through the lens. The housing houses the base portion and the image sensor. The fixing member disposes the base portion and the housing in a state of contact in a direction of the optical axis, and fixes the base portion and the housing. In the imaging apparatus, the fixing member includes a head portion that sandwiches the housing together with the base portion. A coefficient of linear expansion of the housing and a coefficient of linear expansion of the fixing member differ. A length in a direction of the optical axis from a portion of the base portion in contact with the housing to an end portion on a side opposite the portion in contact with the housing is longer than a length in the direction of the optical axis from a portion of the housing in contact with the head portion to a portion in contact with the base portion.

### BRIEF DESCRIPTION OF THE DRAWINGS

In the accompanying drawings:

FIG. 1 is a perspective view of an imaging apparatus according to a first embodiment;

FIG. 2 is an enlarged cross-sectional view taken along line II-II in FIG. 1;

FIG. 3 is an enlarged cross-sectional view taken along line III-III in FIG. 1;

FIG. 4 is an enlarged cross-sectional view taken along line IV-IV in FIG. 1;

FIG. 5 is an enlarged cross-sectional view taken along line V-V in FIG. 1;

FIG. 6 is an enlarged cross-sectional view taken along line VI-VI in FIG. 1;

FIG. 7 is an enlarged cross-sectional view taken along line VII-VII in FIG. 1;

FIG. 8 is a reduced cross-sectional view taken along line VIII-VIII in FIG. 2, FIG. 3, FIG. 4, FIG. 5, FIG. 6, and FIG. 7;

FIG. 9 is a diagram illustrating force acting on a first holder and a second holder of the imaging apparatus;

FIG. 10 is a diagram illustrating a portion of the imaging apparatus viewed from X in FIG. 1;

FIG. 11 is a cross-sectional view of an imaging apparatus in a comparative example;

FIG. 12 is a cross-sectional view of the imaging apparatus in the comparative example when temperature is high;

FIG. 13 is a cross-sectional view of the imaging apparatus of the comparative example when temperature is low;

FIG. 14 is a diagram illustrating a first fixing member and a second fixing member of the imaging apparatus in the comparative example;

FIG. 15 is a diagram illustrating a portion of an imaging apparatus according to a second embodiment;

FIG. 16 is a diagram illustrating a portion of an imaging apparatus according to a third embodiment;

FIG. 17 is a cross-sectional view of an imaging apparatus according to a fourth embodiment;

FIG. 18 is a cross-sectional view of the imaging apparatus;

FIG. 19 is a cross-sectional view of an imaging apparatus according to a fifth embodiment; and

FIG. 20 is a cross-sectional view of the imaging apparatus.

### DESCRIPTION OF THE EMBODIMENTS

Conventionally, as described in JP 2017-158098 A, a camera apparatus that includes a camera case and a camera module has been known. The camera case is fixed to a front windshield of a vehicle from inside a vehicle cabin. The camera module includes an optical unit and a camera board. The optical unit includes a lens. The camera board includes an image sensor and is fixed to an end portion of the optical unit. The camera module is fixed to the camera case. The optical unit includes a lens barrel portion and a base portion. The lens barrel portion holds the lens therein. The base portion includes a reference surface and is fixed to the lens barrel portion. The reference surface serves as reference for positioning when the camera module is fixed to the camera case. In addition, the camera case and the camera module are fixed by an inner wall on a left-side surface and an inner wall on a right-side surface of the camera case and the base portion being fixed together by screws.

In a camera apparatus such as that described in JP 2017-158098 A, a coefficient of linear expansion of the camera module and a coefficient of linear expansion of the screw may differ. If the coefficient of linear expansion of the camera module and the coefficient of linear expansion of the screw differ, thermal stress may be generated in the camera case, the camera module, and the screw due to temperature changes in the camera module and the screw, and fixing force between the screw and the camera module may decrease. The generated thermal stress and the reduced fixing force may cause an attitude of the camera module to change. If the attitude of the camera module changes, an optical axis of the lens shifts, causing an imaging range of the camera apparatus to shift.

It is thus desired to provide an imaging apparatus that suppresses shifting of an optical axis of a lens caused by temperature change.

An exemplary embodiment of the present disclosure provides an imaging apparatus that includes: a lens; a holder that includes a housing portion that houses the lens and a base portion that is connected to the housing portion and extends in a direction orthogonal to an optical axis of the lens; an image sensor that outputs a signal corresponding to a captured image based on light passing through the lens; a housing that houses the base portion and the image sensor; and a fixing member that disposes the base portion and the housing in a state of contact in a direction of the optical axis, and fixes the base portion and the housing. In the imaging apparatus: the fixing member includes a head portion that sandwiches the housing together with the base portion; a coefficient of linear expansion of the housing and a coefficient of linear expansion of the fixing member differ; and a length in a direction of the optical axis from a portion of the base portion in contact with the housing to an end portion on a side opposite the portion in contact with the housing is longer than a length in the direction of the optical axis from a portion of the housing in contact with the head portion to a portion in contact with the base portion.

Therefore, the length of the portion of the housing fixed by the fixing member is relatively short. As a result, increase in an amount of expansion and an amount of contraction in the housing accompanying temperature change is suppressed. Therefore, increase in thermal stress generated in the housing is suppressed, and decrease in fixing force between the housing and the fixing member is suppressed. Consequently, shifting of the optical axis caused by temperature change is suppressed.

Here, reference numbers in parentheses attached to the constituent elements and the like indicate examples of corresponding relationships between the constituent elements and the like and specific constituent elements and the like described according to the embodiments described hereafter.

Embodiments will hereinafter be described with reference to the drawings. Here, sections according to the embodiments described below that are identical or equivalent to each other are given the same reference numbers. Descriptions thereof are omitted.

### First Embodiment

An imaging apparatus according to a present embodiment suppresses shifting of an optical axis of a lens that occurs as a result of temperature change. In addition, for example, the imaging apparatus may be a stereo camera and used in a vehicle (not shown). Furthermore, for example, the imaging apparatus may be disposed near a windshield inside a vehicle cabin and may capture images of an area ahead of the vehicle. Here, the imaging apparatus is not limited to that which captures images of the area ahead of the vehicle and may capture images of the area surrounding the vehicle such as to the left, to the right, or behind the vehicle.

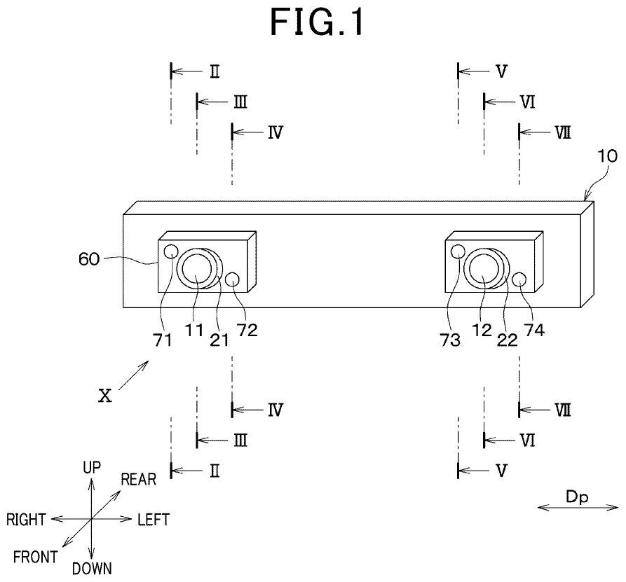

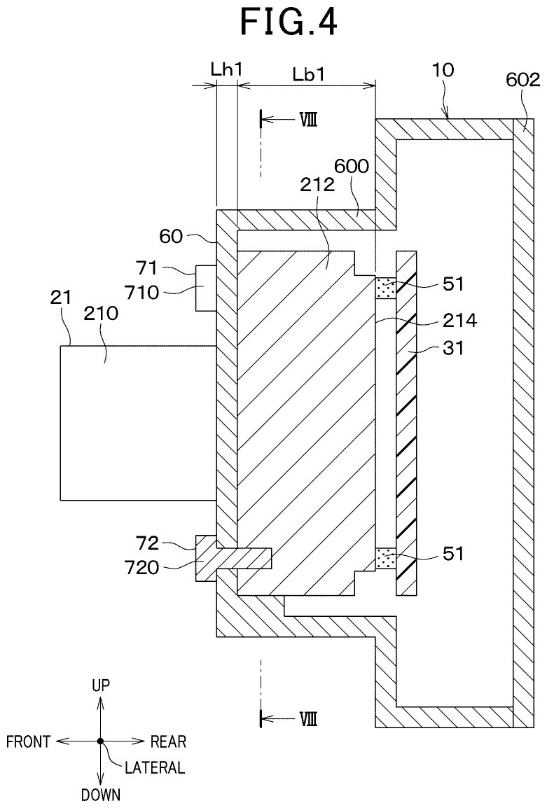

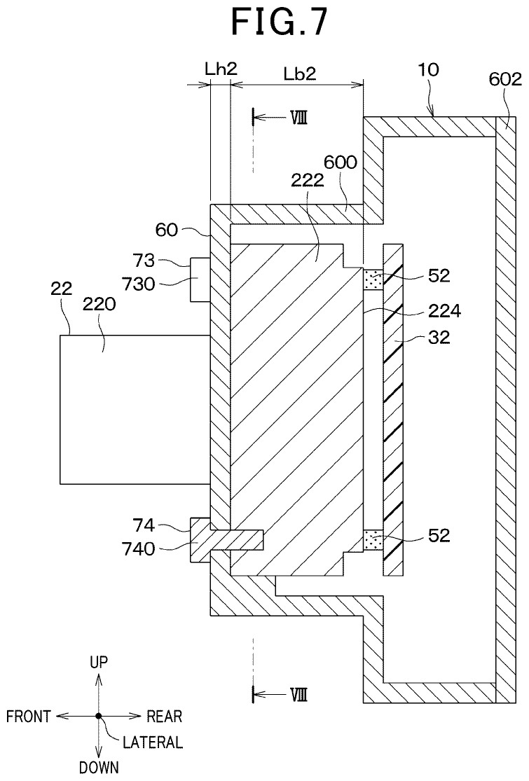

Specifically, as shown in FIG. 1 to FIG. 10, an imaging apparatus 10 includes a first lens 11, a first holder 21, a first board 31, a first image sensor 41, and a first board fixing member 51. In addition, the imaging apparatus 10 includes a second lens 12, a second holder 22, a second board 32, a second image sensor 42, and a second board fixing member 52. Furthermore, the imaging apparatus 10 includes a housing 60, a first fixing member 71, a second fixing member 72, a third fixing member 73, and a fourth fixing member 74.

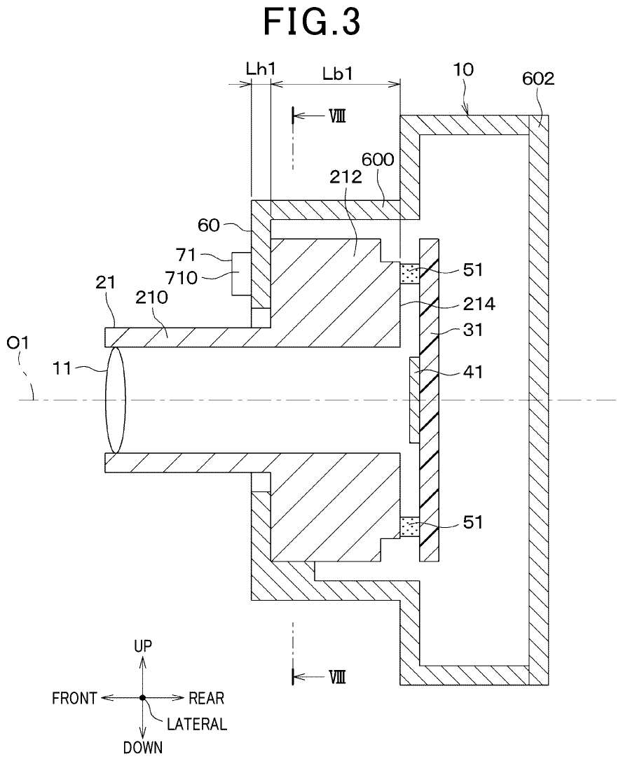

As shown in FIG. 1 and FIG. 3, the first lens 11 collects light from ahead of the vehicle to capture images of the area ahead of the vehicle. Here, a first optical axis O1 that is an optical axis of the first lens 11 extends in a longitudinal (front/rear) direction of the vehicle.

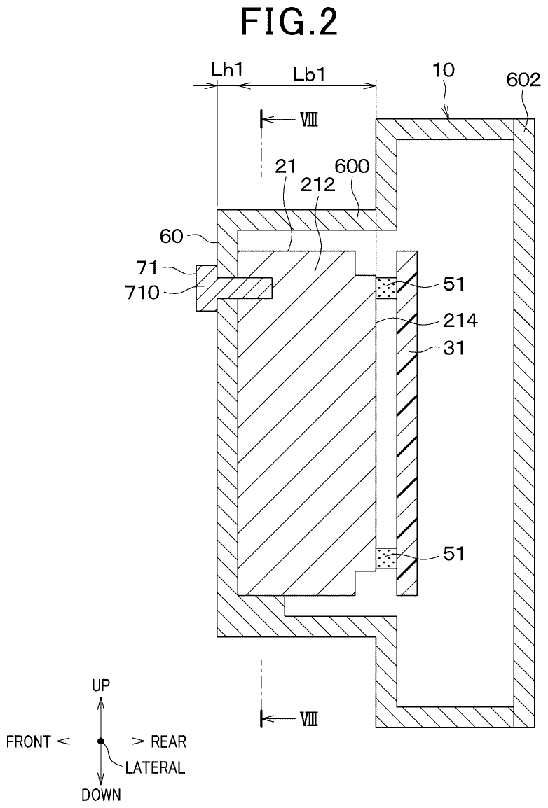

The first holder 21 is formed of a metal such as aluminum or copper, resin, and or like. In addition, as shown in FIG. 2 to FIG. 4, the first holder 21 has a first housing portion 210 and a first base portion 212.

The first housing portion 210 is formed into a cylindrical shape that extends in the first optical axis O1 direction. In addition, the first housing portion 210 houses the first lens 11. The first base portion 212 is connected to the first housing portion 210. Furthermore, the first base portion 212 extends from the first housing portion 210 in a direction orthogonal to the first optical axis O1.

The first board 31 is a printed circuit board. The first image sensor 41 is a semiconductor image sensor element such as a complementary metal-oxide semiconductor (CMOS) image sensor. In addition, as shown in FIG. 3, the first image sensor 41 is mounted on the first board 31 on a surface opposing the first lens 11 in the first optical axis O1 direction. Therefore, the first image sensor 41 outputs a signal corresponding to a captured image based on light passing through the first lens 11. Furthermore, the first board 31 acquires the signal from the first image sensor 41. The first board 31 then outputs the signal from the first image sensor 41 to an image recognition apparatus (not shown), for example.

For example, the first board fixing member 51 may be an adhesive or the like, and may be adhered to the first board 31 on a surface on which the first image sensor 41 is mounted and a first end portion 214 of the first base portion 212. As a result, the first board fixing member 51 fixes the first holder 21 and the first board 31. Here, the first end portion 214 is an end portion of the first base portion 121 on a side opposite the first housing portion 210.

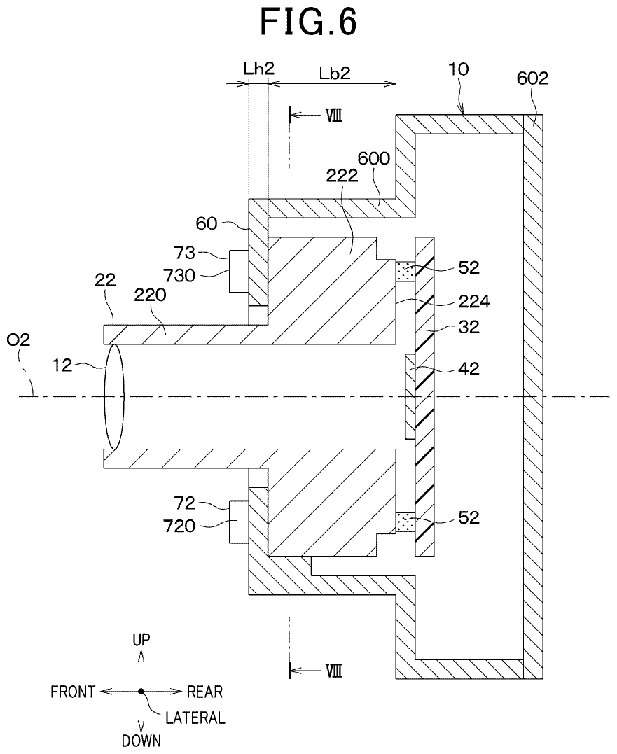

As shown in FIG. 1 and FIG. 6, the second lens 12 collects light from ahead of the vehicle to capture images of the area ahead of the vehicle. Here, a second optical axis O2 that is an optical axis of the second lens 12 extends in the longitudinal direction of the vehicle. In addition, the second optical axis O2 is parallel to the first optical axis O1.

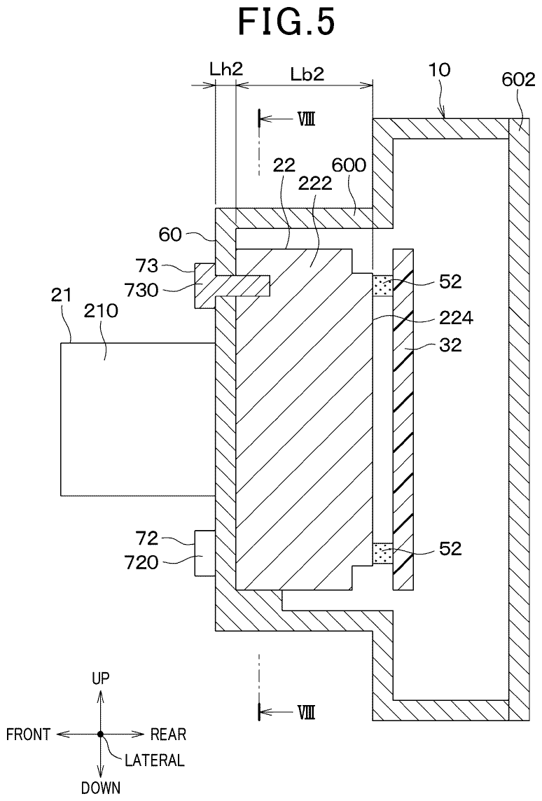

The second holder 22 is formed of a metal such as aluminum or copper, resin, or the like. In addition, as shown in FIG. 5 to FIG. 7, the second holder 22 has a second housing portion 220 and a second base portion 222.

The second housing portion 220 is formed into a cylindrical shape that extends in the second optical axis O2 direction. In addition, the second housing portion 220 houses the second lens 12. The second base portion 222 is connected to the second housing portion 220. Furthermore, the second base portion 222 extends from the second housing portion 220 in a direction orthogonal to the second optical axis O2.

The second board 32 is a printed circuit board. The second image sensor 42 is a semiconductor image sensor element such as a CMOS image sensor. In addition, as shown in FIG. 6, the second image sensor 42 is mounted on the second board 32 on a surface opposing the second lens 12 in the second optical axis O2 direction. Therefore, the second image sensor 42 outputs a signal corresponding to a captured image based on light passing through the second lens 12. Furthermore, the second board 32 acquires the signal from the second image sensor 42. The second board 32 then outputs the signal from the second image sensor 42 to the image recognition apparatus (not shown), for example.

Therefore, the image recognition apparatus calculates a distance from the vehicle to an object ahead of the vehicle using the signals from the first board 31 and the second board 32, and triangulation or the like. In addition, the image recognition apparatus outputs the calculated distance to a driving assistance apparatus (not shown). The driving assistance apparatus performs driving assistance of the vehicle such as adaptive cruise control (ACC) based on the distance calculated by the image recognition apparatus.

For example, the second board fixing member 52 may be an adhesive or the like, and may be adhered to a surface of the second board 32 on which the second image sensor 42 is mounted and a second end portion 224 of the second base portion 222. As a result, the second board fixing member 52 fixes the second holder 22 and the second board 32. Here, the second end portion 224 is an end portion of the second base portion 222 on a side opposite the second housing portion 220.

The housing 60 is formed into a box-like shape using a metal such as aluminum or copper, resin, or the like. In addition, the housing 60 is preferably formed from the same material as the first holder 21 and the second holder 22. Here, “same” includes a manufacturing error range.

As shown in FIG. 2 to FIG. 7, the housing 60 has a housing containment portion 600 and a housing cover portion 602. The housing containment portion 600 houses the first base portion 212, the first image sensor 41, the second base portion 222, and the second image sensor 42. In addition, the housing containment portion 600 is open toward the rear of the vehicle. The housing cover portion 602 covers the opening of the housing containment portion 600.

For example, the first fixing member 71 and the second fixing member 72 may be screws or pins that, as shown in FIG. 2 to FIG. 4, place the first base portion 212 and the housing 60 in a state of contact in the first optical axis O1 direction. In addition, the first fixing member 71 and the second fixing member 72 are partially inserted into holes formed in the first base portion 212 and the housing 60. As a result, the first fixing member 71 and the second fixing member 72 fix the first base portion 212 and the housing 60.

The first fixing member 71 has a first head portion 710. The first head portion 710 is a portion of the first fixing member 71 positioned on a side opposite the first base portion 212, that is, a portion positioned toward the front of the vehicle. The first head portion 710 sandwiches the housing 60 together with the first base portion 212.

In addition, the second fixing member 72 has a second head portion 720. The second head portion 720 is a portion of the second fixing member 72 positioned on a side opposite the first base portion 212, that is, a portion positioned toward the front of the vehicle. The second head portion 720 sandwiches the housing 60 together with the first base portion 212.

For example, the third fixing member 73 and the fourth fixing member 74 may be screws or pins that, as shown in FIG. 5 to FIG. 7, place the second base portion 222 and the housing 60 in a state of contact in the second optical axis O2 direction. In addition, the third fixing member 73 and the fourth fixing member 74 are partially inserted into holes formed in the second base portion 222 and the housing 60. As a result, the third fixing member 73 and the fourth fixing member 74 fix the second base portion 222 and the housing 60.

The third fixing member 73 has a third head portion 730. The third head portion 730 is a portion of the third fixing member 73 positioned on a side opposite the second base portion 222, that is, a portion positioned toward the front of the vehicle. The third head portion 730 sandwiches the housing 60 together with the second base portion 222.

In addition, the fourth fixing member 74 has a fourth head portion 740. The fourth head portion 740 is a portion of the fourth fixing member 74 positioned on a side opposite the second base portion 222, that is, a portion positioned toward the front of the vehicle. The fourth head portion 740 sandwiches the housing 60 together with the second base portion 222.

Here, a coefficient of linear expansion of the housing 60 is αh. A coefficient of linear expansion of the first fixing member 71 is α1. A coefficient of linear expansion of the second fixing member 72 is α2. A coefficient of linear expansion of the third fixing member 73 is α2. A coefficient of linear expansion of the fourth fixing member 74 is α4.

In addition, the coefficient of linear expansion of the housing 60 differs from the coefficients of linear expansion of the first fixing member 71, the second fixing member 72, the third fixing member 73, and the fourth fixing member 74. That is, αh≠α1, αh≠α2, αh≠α3, and αh≠α4. Here, α1, α2, α3, and α4 may differ from one another or may be the same. In addition, αh, α1, α2, α3, and α4 are measured by the coefficients of linear expansion of the materials of the housing 60, the first fixing member 71, the second fixing member 72, the third fixing member 73, and the fourth fixing member 74 being measured. For example, the coefficients of linear expansion of the materials may be measured in compliance with JIS Z 2285, JIS K 7197, and the like.

Furthermore, here, as shown in FIG. 2 to FIG. 4, a length from a portion of the first base portion 212 in contact with the housing 60 to the first end portion 214 on the first optical axis O1 is a first base length Lb1. A length from a portion of the housing 60 in contact with the first head portion 710 or the second head portion 720 to a portion in contact with the first base portion 212 on the first optical axis O1 is a first housing length Lh1. Here, the first end portion 214 corresponds to an end portion of the first base portion 212 on a side opposite the portion in contact with the housing 60.

In addition, as shown in FIG. 5 to FIG. 7, a length from a portion of the second base portion 222 in contact with the housing 60 to the second end portion 224 on the second optical axis O2 is a second base length Lb2. A length from a portion of the housing 60 in contact with the third head portion 730 or the fourth head portion 740 to a portion in contact with the second base portion 222 on the second optical axis O2 is a second housing length Lh2. Here, the second end portion 224 corresponds to an end portion of the second base portion 222 on a side opposite the portion in contact with the housing 60.

Furthermore, as shown in FIG. 2 to FIG. 4, the first base length Lb1 is longer than the first housing length Lh1. That is, Lb1>Lh1. Moreover, as shown in FIG. 5 to FIG. 7, the second base length Lb2 is longer than the second housing length Lh2. That is, Lb2>Lh2.

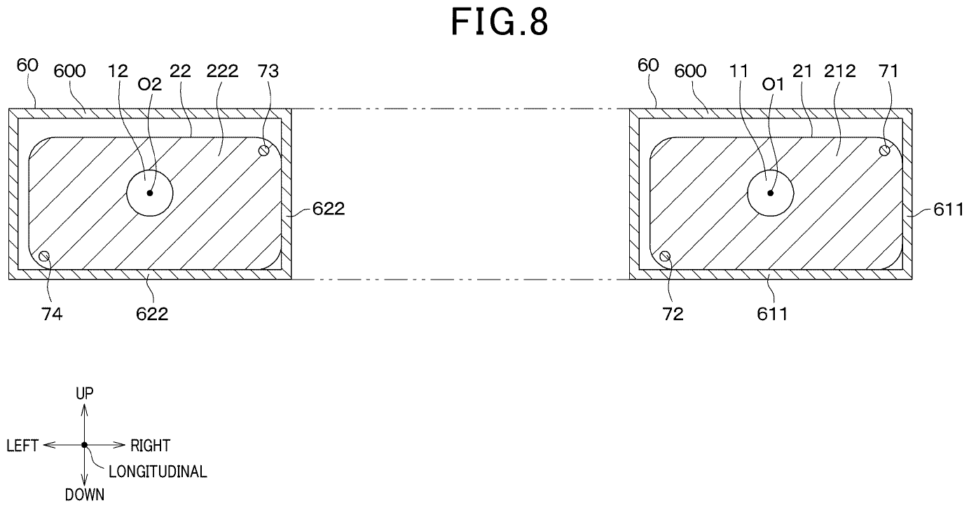

Here, as shown in FIG. 8, an inner wall of the housing 60 is in contact with the first base portion 212 in a direction orthogonal to the first optical axis O1. The portion of the housing 60 that is in contact with the first base portion 212 in the direction orthogonal to the first optical axis O1 is a first contact portion 611. In addition, the inner wall of the housing 60 is in contact with the second base portion 222 in a direction orthogonal to the second optical axis O2. The portion of the housing 60 that is in contact with the second base portion 222 in the direction orthogonal to the second optical axis O2 is a second contact portion 622.

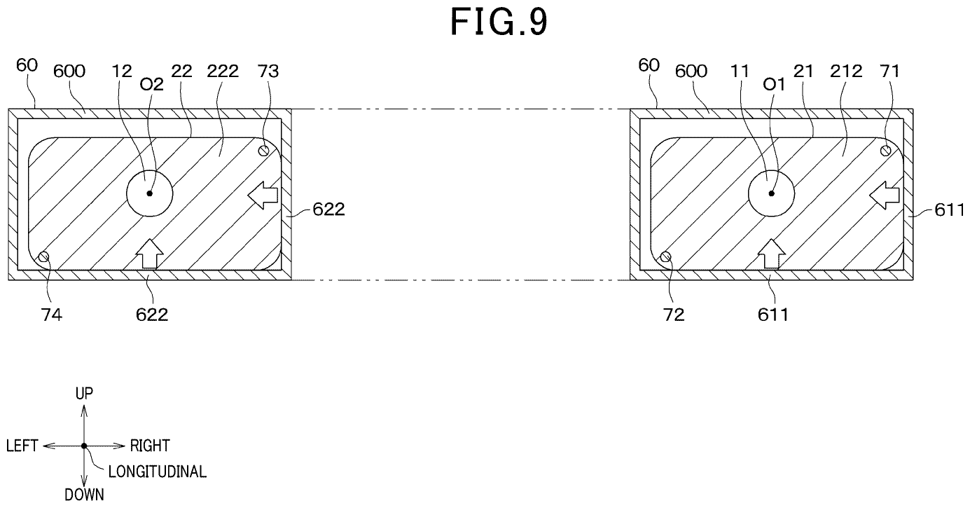

As shown in FIG. 9, a direction of force acting on the first base portion 212 from the first contact portion 611 and a direction of force acting on the second base portion 222 from the second contact portion 622 are the same direction. Here, in FIG. 9, the force acting on the first base portion 212 from the first contact portion 611 and the force acting on the second base portion 222 from the second contact portion 622 are schematically indicated by arrows. In addition, here, although two first contact portions 611 and two second contact portions 622 are present, the quantities are not limited to two. One, or three or more first contact portions 611 and second contact portions 622 may be present.

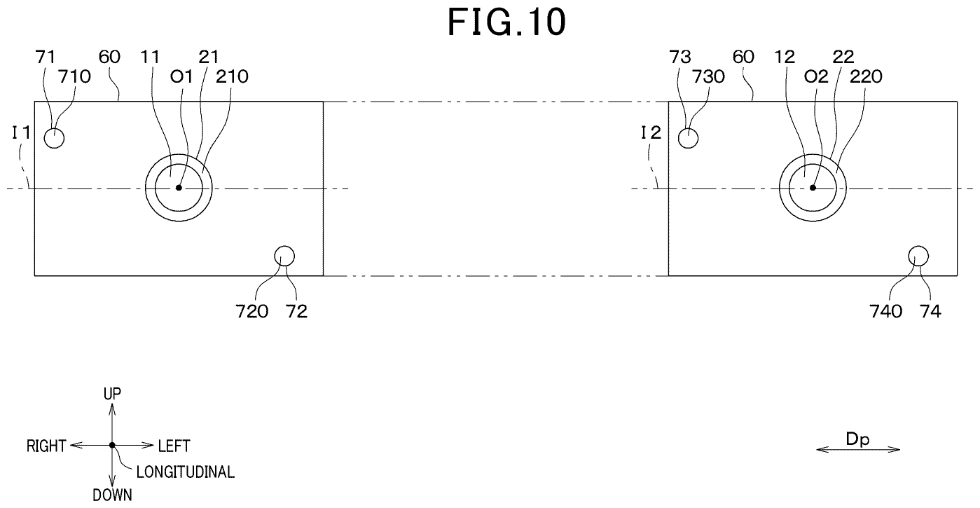

Moreover, as shown in FIG. 1 and FIG. 10, a direction in which the first lens 11 and the second lens 12 are arrayed is a parallel direction Dp. Here, the parallel direction Dp coincides with a lateral (left/right) direction of the vehicle. In addition, as shown in FIG. 10, a straight line that passes through the first optical axis O1 and extends in the parallel direction Dp is a first straight line I1. A straight line that that passes through the second optical axis O2 and extends in the parallel direction Dp is a second straight line I2.

The first fixing member 71 is disposed further toward one side in a direction orthogonal to the first optical axis O1 direction and the parallel direction Dp than the first straight line I1 is. That is, here, the first fixing member 71 is disposed further toward an upper side of the vehicle than the first straight line I1 is. The second fixing member 72 is disposed further toward another side in the direction orthogonal to the first optical axis O1 direction and the parallel direction Dp than the first straight line I1 is. That is, here, the second fixing member 72 is disposed further toward a lower side of the vehicle than the first straight line I1 is.

In addition, the third fixing member 73 is disposed further toward one side in a direction orthogonal to the second optical axis O2 direction and the parallel direction Dp than the second straight line I2 is. That is, here, the second fixing member 72 is disposed further toward the upper side of the vehicle than the second straight line I2 is. The fourth fixing member 74 is disposed further toward another side in the direction orthogonal to the second optical axis O2 direction and the parallel direction Dp than the second straight line I2 is. That is, here, the fourth fixing member 74 is disposed further toward the lower side of the vehicle than the second straight line I2 is.

The imaging apparatus 10 according to the first embodiment is configured as described above. Next, suppression of shifting of the first optical axis O1 and the second optical axis O2 caused by temperature change in the imaging apparatus 10 according to the present embodiment will be described.

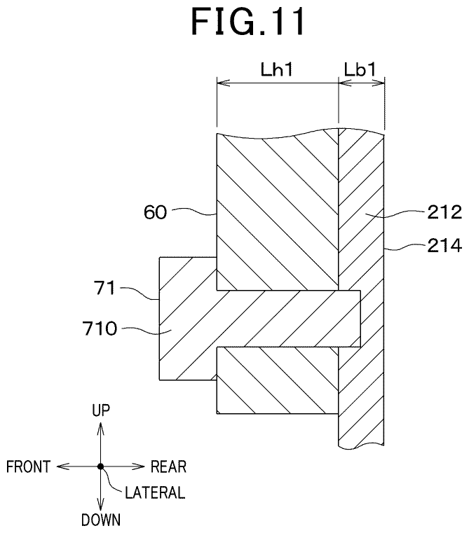

Here, in a case in which the first base portion 212 and the housing 60 are fixed by the first fixing member 71 as shown in FIG. 11 as a comparative example, the first base length Lb1 is equal to or less than the first housing length Lh1. That is, Lb1≤Lh1.

In this case, the coefficient of linear expansion of the housing 60 is greater than the coefficient of linear expansion of the first fixing member 71. That is, αh>α1.

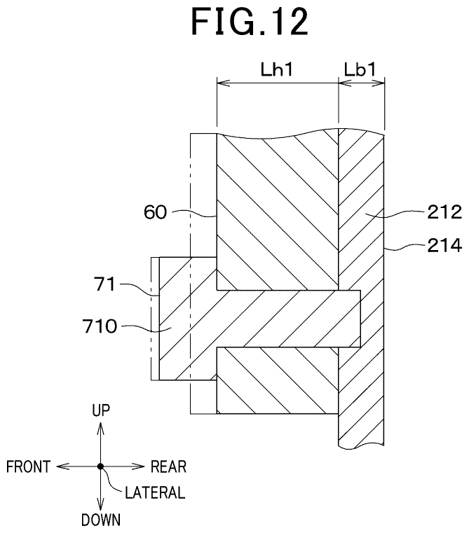

At this time, if the temperatures of the housing 60 and the first fixing member 71 increase, because αh>α1, as shown in FIG. 12, an amount of expansion of the housing 60 in the first optical axis O1 direction is greater than an amount of expansion of the first fixing member 71 in the first optical axis O1 direction. As a result, strain in the housing 60 in the first optical axis O1 direction becomes relatively large. Furthermore, the housing 60 is retrained by the first base portion 212 and the first fixing member 71. Therefore, thermal stress is also generated in the housing 60. The generated thermal stress is applied to the housing 60, the first fixing member 71, and the first base portion 212. Consequently, an attitude of the first base portion 212 may change. If the attitude of the first base portion 212 changes, an attitude of the first holder 21 changes. If the attitude of the first holder 21 changes, an attitude of the first lens 11 changes. If the attitude of the of the first lens 11 changes, the first optical axis O1 shifts. Here, in FIG. 12, the amounts of expansion of the housing 60 and the first fixing member 71 are schematically indicated by two-dot chain lines.

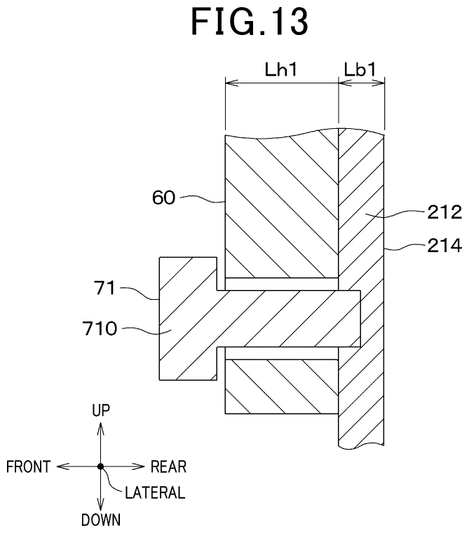

In addition, at this time, if the temperatures of the housing 60 and the first fixing member 71 decrease, because αh>α1, as shown in FIG. 13, an amount of contraction of the housing 60 is greater than an amount of contraction of the first fixing member 71. As a result, because repulsive force on the housing 60 generated as a result of the first fixing member 71 being pulled in the first optical axis O1 direction decreases, fixing force between the housing 60 and the first fixing member 71 decreases. Consequently, the fixing force between the housing 60 and the first base portion 212 decreases. If the fixing force between the housing 60 and the first base portion 212 decreases, the attitude of the first base portion 212 may change. If the attitude of the first base portion 121 changes, the first optical axis O1 shifts as described above.

Furthermore, when Lb1≤Lh1, the coefficient of linear expansion of the housing 60 is less than the coefficient of linear expansion of the first fixing member 71. That is, αh<α1.

At this time, if the temperatures of the housing 60 and the first fixing member 71 increase, because αh<α1, the amount of expansion of the first fixing member 71 in the first optical axis O1 direction is greater than the amount of expansion of the housing 60 in the first optical axis O1 direction. As a result, because repulsive force on the housing 60 generated as a result of the first fixing member 71 being pulled in the first optical axis O1 direction decreases, fixing force between the housing 60 and the first fixing member 71 decreases. Consequently, the fixing force between the housing 60 and the first base portion 212 decreases. If the fixing force between the housing 60 and the first base portion 212 decreases, the attitude of the first base portion 212 may change. If the attitude of the first base portion 121 changes, the first optical axis O1 shifts as described above.

In addition, at this time, if the temperatures of the housing 60 and the first fixing member 71 decrease, because αh<α1, the amount of contraction of the first fixing member 71 is greater than the amount of contraction of the housing 60. As a result, strain in the first fixing member 71 in the first optical axis O1 direction becomes relatively large. Furthermore, the first fixing member 71 is retrained by the housing 60. Therefore, thermal stress is also generated in the first fixing member 71. The generated thermal stress is applied to the first fixing member 71, the housing 60, and the first base portion 212. Therefore, the attitude of the first base portion 212 may change. If the attitude of the first base portion 212 changes, the first optical axis O1 shifts as described above.

In contrast, in the imaging apparatus 10 according to the present embodiment, while αh≠α1 and αh≠α2, as shown in FIG. 2 to FIG. 4, the first base length Lb1 is longer than the first housing length Lh1. That is, Lb1>Lh1.

Therefore, a length of a portion of the housing 60 fixed by the first fixing member 71 and the second fixing member 72 is relatively short. As a result, increase in the amount of expansion and the amount of contraction of the housing 60 accompanying temperature change in the housing 60 is suppressed. Therefore, increased in strain in the housing 60 accompanying temperature change in the housing 60 is suppressed. As a result, increase in thermal stress generated in the housing 60 is suppressed. Therefore, attitude change in the first base portion 212 as a result of thermal stress is suppressed. Consequently, shifting of the first optical axis O1 is suppressed.

In addition, because increase in the amount of expansion and the amount of contraction in the housing 60 caused by temperature change in the housing 60 is suppressed, decrease in the repulsive force on the housing 60 generated as a result of the first fixing member 71 being pulled in the first optical axis O1 direction is suppressed. Therefore, decrease in the fixing force between the housing 60 and the first fixing member 71 is suppressed. As a result, decrease in the fixing force between the housing 60 and the first base portion 212 is suppressed. Therefore, shifting of the first optical axis O1 is suppressed. Consequently, shifting of the first optical axis O1 occurring as a result of temperature change is suppressed.

Furthermore, while αh≠α3 and αh≠α4, as shown in FIG. 5 to FIG. 7, the second base length Lb2 is longer than the second housing length Lh2. That is, Lb2>Lh2.

As a result, a length of a portion of the housing 60 fixed by the third fixing member 73 and the fourth fixing member 74 is relatively short. Consequently, in a manner similar to that described above, shifting of the second optical axis O2 occurring as a result of temperature change is suppressed.

The imaging apparatus 10 according to the first embodiment also achieves the effects described below.

[1-1] Here, creep occurs in the first base portion 212, the second base portion 222, and the housing 60 in accompaniment with elapse of time when thermal stress is generated in the first base portion 212, the second base portion 222, and the housing 60. At this time, if the direction of force acting on the first base portion 212 from the first contact portion 611 and the direction of force acting on the second base portion 222 from the second contact portion 622 differ, a positional shift direction of the first base portion 212 and a positional shift direction of the second base portion 222 differ. If the positional shift direction of the first base portion 212 and the positional shift direction of the second base portion 222 differ, a positional shift direction of the first holder 21 and a positional shift direction of the second holder 22 differ. If the positional shift direction of the first holder 21 and the positional shift direction of the second holder 22 differ, a positional relationship between the first optical axis O1 and the second optical axis O2 shifts. Therefore, if the direction of force acting on the first base portion 212 from the first contact portion 611 and the direction of force acting on the second base portion 222 from the second contact portion 622 differ, the positional relationship between the first optical axis O1 and the second optical axis O2 changes in accompaniment with the elapse of time. If the positional relationship between the first optical axis O1 and the second optical axis O2 changes, accuracy of calculation of the distance from the vehicle to an object ahead of the vehicle using triangulation and the like by the image recognition apparatus decreases.

In contrast, as shown in FIG. 8 and FIG. 9, in the imaging apparatus 10 according to the first embodiment, the direction of force acting on the first base portion 212 from the first contact portion 611 and the direction of force acting on the second base portion 222 from the second contact portion 622 are the same direction.

As a result, the change in positional relationship between the first optical axis O1 and the second optical axis O2 caused by creep is suppressed. Consequently, decrease in accuracy of the calculation of the distance from the vehicle to an object ahead of the vehicle using triangulation and the like by the image recognition apparatus is suppressed.

[1-2] Here, a difference in expansion between the first base portion 212 and the housing 60 occurs due to temperature rise in the first base portion 212 and the housing 60. As a result, thermal stress may be generated in the first base portion 212 and the housing 60. The thermal stress generated in the first base portion 212 and the housing 60 may cause the attitude of the first holder 21 to change. If the attitude of the first holder 21 changes, the first optical axis O1 shifts. In addition, a difference in expansion between the second base portion 222 and the housing 60 occurs due to temperature rise in the second base portion 222 and the housing 60. As a result, thermal stress may be generated in the second base portion 222 and the housing 60. The thermal stress generated in the second base portion 222 and the housing 60 may cause the attitude of the second holder 22 to change. If the attitude of the second holder 22 changes, the second optical axis O2 shifts. Due to the foregoing, the first holder 21, the second holder 22, and the housing 60 are preferably formed of the same material.

As a result, the coefficient of linear expansion of the first base portion 212 and the coefficient of linear expansion of the housing 60 can be more easily made the same. Therefore, the difference in expansion between the first base portion 212 and the housing 60 due to temperature rise in the first base portion 212 and the housing 60 is suppressed. As a result, increase in thermal stress generated in the first base portion 212 and the housing 60 is suppressed. Consequently, shifting of the first optical axis O1 caused by temperature change is suppressed.

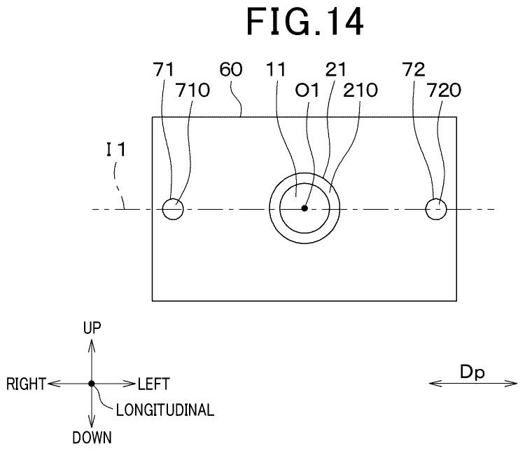

In addition, the coefficient of linear expansion of the second base portion 222 and the coefficient of linear expansion of the housing 60 can be more easily made the same. Therefore, the difference in expansion between the second base portion 222 and the housing 60 due to temperature rise in the second base portion 222 and the housing 60 is suppressed. As a result, increase in thermal stress generated in the second base portion 222 and the housing 60 is suppressed. Consequently, shifting of the second optical axis O2 caused by temperature change is suppressed.

[1-3] Here, the first base portion 212 may rotate around a line connecting the first fixing member 71 and the second fixing member 72. In addition, as shown in FIG. 14, the first fixing member 71 and the second fixing member 72 are arrayed on the first straight line I1. At this time, an amount of rotation of the first base portion 212 around the straight line extending in the parallel direction Dp is relatively large.

In contrast, as shown in FIG. 10, in the imaging apparatus 10 according to the first embodiment, the first fixing member 71 is disposed further toward one side in the direction orthogonal to the first optical axis O1 direction and the parallel direction Dp than the first straight line I1 is. The second fixing member 72 is disposed further toward the other side in the direction orthogonal to the first optical axis O1 direction and the parallel direction Dp than the first straight line I1 is.

As a result, because the line connecting the first fixing member 71 and the second fixing member 72 intersect the first straight line I1, rotation of the first base portion 212 around the straight line extending in the parallel direction Dp is suppressed, compared to the case described above. Therefore, rotation of the first holder 21 around the straight line extending in the parallel direction Dp is suppressed. As a result, rotation of the first lens 11 around the straight line extending in the parallel direction Dp is suppressed. Consequently, shifting of the first optical axis O1 in a rotation direction around the straight line extending in the parallel direction Dp is suppressed.

In addition, the third fixing member 73 is disposed further toward one side in the direction orthogonal to the second optical axis O2 direction and the parallel direction Dp than the second straight line I2 is. The fourth fixing member 74 is disposed further toward the other side in the direction orthogonal to the second optical axis O2 direction and the parallel direction Dp than the second straight line I2 is.

As a result, because the line connecting the third fixing member 73 and the fourth fixing member 74 intersect the second straight line I2, rotation of the second base portion 222 around the straight line extending in the parallel direction Dp is suppressed. Therefore, rotation of the second holder 22 around the straight line extending in the parallel direction Dp is suppressed. As a result, rotation of the second lens 12 around the straight line extending in the parallel direction Dp is suppressed. Consequently, shifting of the second optical axis O2 in a rotation direction around the straight line extending in the parallel direction Dp is suppressed.

### Second Embodiment

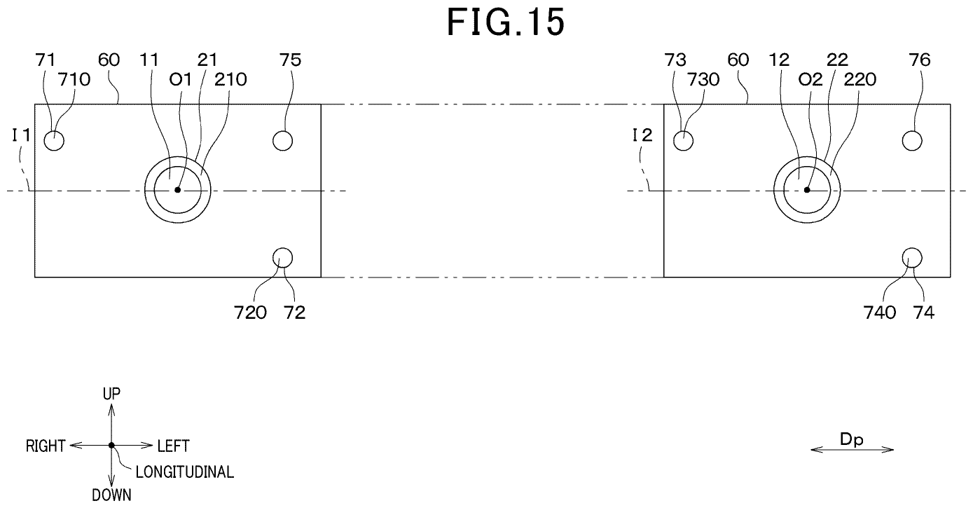

As shown in FIG. 15, according to a second embodiment, the imaging apparatus 10 further includes a fifth fixing member 75 and a sixth fixing member 76. Other configurations are similar to those according to the first embodiment.

For example, the fifth fixing member 75 may be a screw or a pin that disposes the first base portion 212 and the housing 60 in a state of contact in the first optical axis O1 direction. In addition, the fifth fixing member 75 is partially inserted into holes formed in the first base portion 212 and the housing 60. As a result, the fifth fixing member 75 fixes the first base portion 212 and the housing 60 together with the first fixing member 71 and the second fixing member 72.

Furthermore, a triangular plane is formed by line segments connecting the first fixing member 71, the second fixing member 72, and the fifth fixing member 75. Therefore, the fifth fixing member 75 is not positioned on a straight line connecting the first fixing member 71 and the second fixing member 72.

For example, the sixth fixing member 76 may be a screw or a pin that disposes the second base portion 222 and the housing 60 in a state of contact in the second optical axis O2 direction. In addition, the sixth fixing member 76 is partially inserted into holes formed in the second base portion 222 and the housing 60. As a result, the sixth fixing member 76 fixes the second base portion 222 and the housing 60 together with the third fixing member 73 and the fourth fixing member 74.

Furthermore, a triangular plane is formed by line segments connecting the third fixing member 73, the fourth fixing member 74, and the sixth fixing member 76. Therefore, the sixth fixing member 76 is not positioned on a straight line connecting the third fixing member 73 and the fourth fixing member 74.

The imaging apparatus 10 according to the second embodiment is configured as described above. Effects similar to those according to the first embodiment may also be obtained in the second embodiment. Furthermore, effects described below are also obtained according to the second embodiment.

[2] Here, as described above, the first base portion 212 may rotate around a line connecting the first fixing member 71 and the second fixing member 72.

In contrast, as shown in FIG. 15, in the imaging apparatus 10 according to the second embodiment, a plane is formed by the line segments connecting the first fixing member 71, the second fixing member 72, and the fifth fixing member 75.

As a result, the rotation of the first base portion 212 around the line connecting the first fixing member 71 and the second fixing member 72 is suppressed. In addition, the rotation of the first base portion 212 around the line connecting the first fixing member 71 and the fifth fixing member 75 is surpassed. Furthermore, the rotation of the first base portion 212 around the line connecting the second fixing member 72 and the fifth fixing member 75 is suppressed. Therefore, rotation of the first base portion 212 is suppressed. As a result, rotation of the first holder 21 is suppressed. Therefore, rotation of the first lens 11 is suppressed. Consequently, shifting of the first optical axis O1 is suppressed.

In addition, a plane is formed by the line segments connecting the third fixing member 73, the fourth fixing member 74, and the sixth fixing member 76.

As a result, the rotation of the second base portion 222 around the line connecting the third fixing member 73 and the fourth fixing member 74 is suppressed. In addition, the rotation of the second base portion 222 around the line connecting the third fixing member 73 and the sixth fixing member 76 is surpassed. Furthermore, the rotation of the second base portion 222 around the line connecting the fourth fixing member 74 and the sixth fixing member 76 is suppressed. Therefore, rotation of the second base portion 222 is suppressed. As a result, rotation of the second holder 22 is suppressed. Therefore, rotation of the second lens 12 is suppressed. Consequently, shifting of the second optical axis O2 is suppressed.

### Third Embodiment

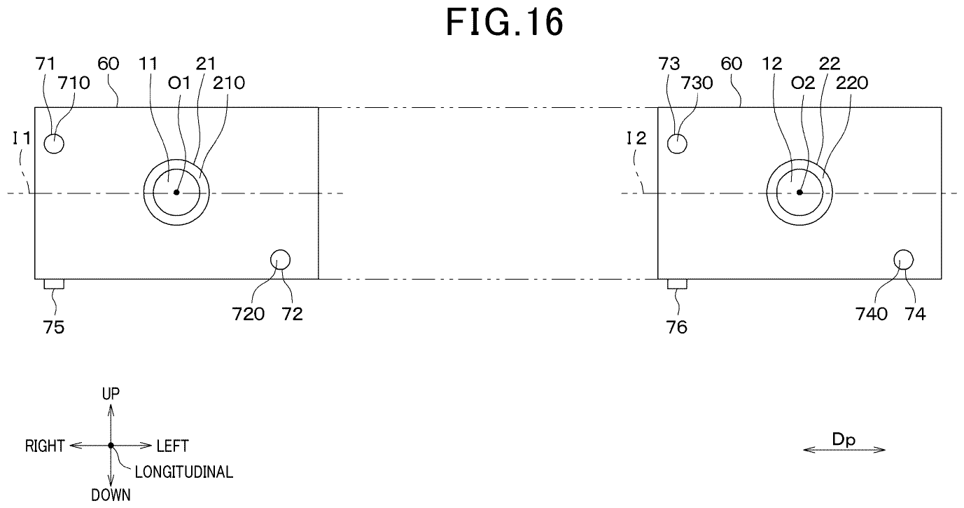

As shown in FIG. 16, according to a third embodiment, aspects of the fifth fixing member 75 and the sixth fixing member 76 differ from those according to the second embodiment. Other configurations are similar to those according to the second embodiment. The fifth fixing member 75 disposes the first base portion 212 and the housing in a state of contact in the direction orthogonal to the first optical axis O1, instead of the first optical axis O1 direction. The sixth fixing member 76 disposes the second base portion 222 and the housing in a state of contact in the direction orthogonal to the second optical axis O2, instead of the second optical axis O2 direction

The imaging apparatus 10 according to the third embodiment is configured as described above. Effects similar to those according to the second embodiment may also be obtained in the third embodiment.

### Fourth Embodiment

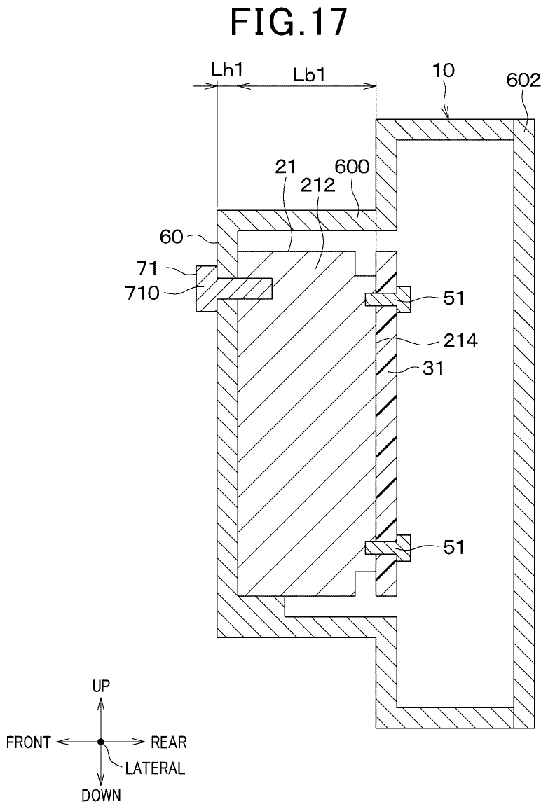

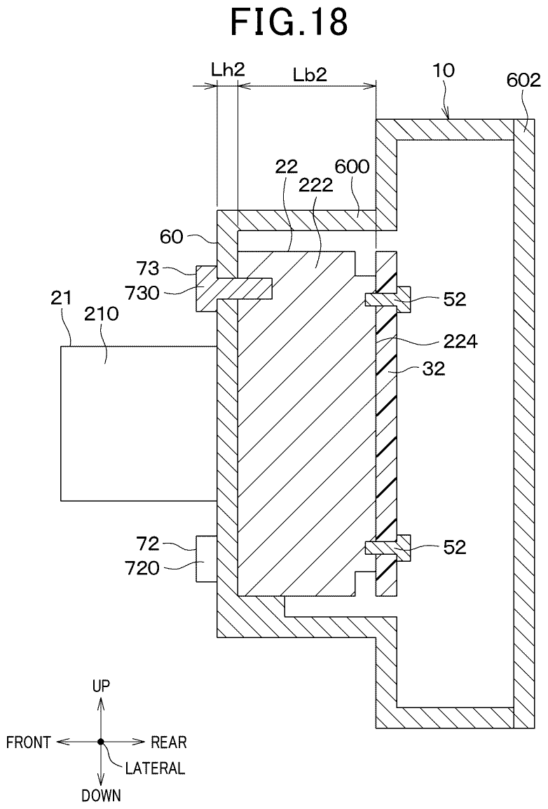

As shown in FIG. 17 and FIG. 18, aspects of the first board fixing member 51 and the second board fixing member 52 according to a fourth embodiment differ from those according to the first embodiment. Other configurations are similar to those according to the first embodiment.

As shown in FIG. 17, the first board fixing member 51 is a screw, a pin, or the like, instead of an adhesive. In addition, the first board fixing member 51 is partially inserted into holes formed in the first end portion 214 and the first board 31. As a result, the first board fixing member 51 fixes the first holder 21 and the first board 31.

As shown in FIG. 18, the second board fixing member 52 is a screw, a pin, or the like, instead of an adhesive. In addition, the second board fixing member 52 is partially inserted into holes formed in the second end portion 224 and the second board 32. As a result, the second board fixing member 52 fixes the second holder 22 and the second board 32.

The imaging apparatus 10 according to the fourth embodiment is configured as described above. Effects similar to those according to the first embodiment may also be obtained in the fourth embodiment.

### Fifth Embodiment

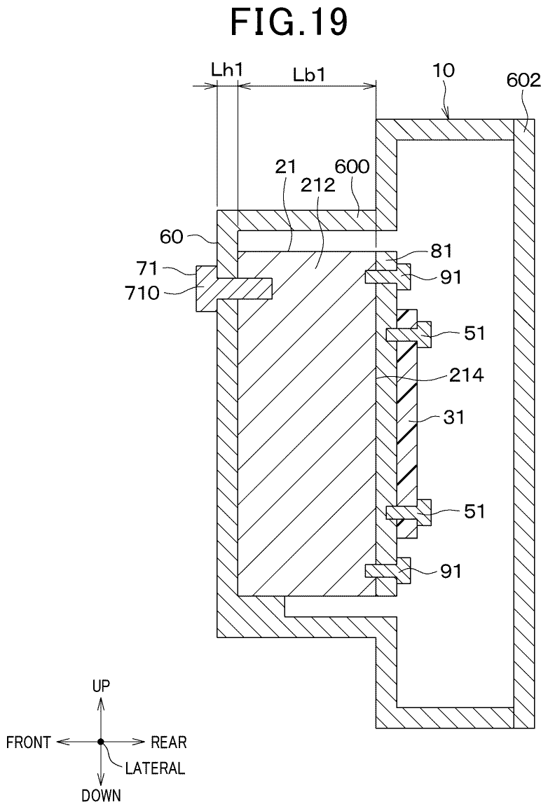

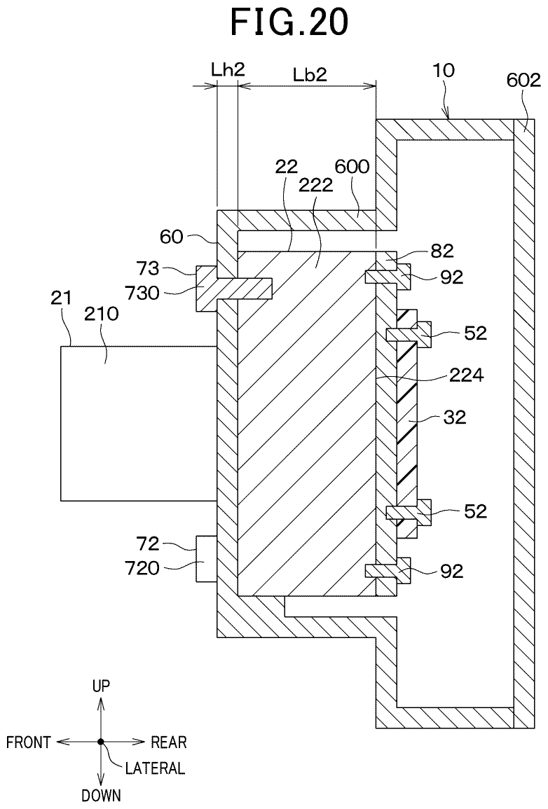

As shown in FIG. 19 and FIG. 20, the imaging apparatus 10 according to a fifth embodiment further includes a first reinforcing portion 81, a first reinforcement fixing member 91, a second reinforcing portion 82, and a second reinforcement fixing member 92. In addition, aspects of the first board fixing member 51 and the second board fixing member 52 differ from those according to the first embodiment. Other configurations are similar to those according to the first embodiment.

As shown in FIG. 19, the first reinforcing portion 81 is formed into a plate-like shape that extends in the direction orthogonal to the first optical axis O1 using metal or the like. For example, the first reinforcement fixing member 91 may be a screw or a pin that disposes the first reinforcing portion 81 and the first end portion 214 in a state of contact in the first optical axis O1 direction. In addition, the first reinforcement fixing member 91 is partially inserted into holes formed in the first reinforcing portion 81 and the first end portion 214. As a result, the first reinforcement fixing member 91 fixes the first base portion 212 and the first reinforcing portion 81.

For example, the first board fixing member 51 may be a screw or a pin that disposes the first board 31 and the first reinforcing portion 81 in a state of contact in the first optical axis O1 direction. In addition, the first board fixing member 51 is partially inserted into holes formed in the first board 31 and the first reinforcing portion 81. As a result, the first board fixing member 51 fixes the first reinforcing portion 81 and the first board 31. Consequently, fixing of the first holder 21 and the first board 31 is reinforced by the first reinforcing portion 81 and the first reinforcement fixing member 91.

As shown in FIG. 20, the second reinforcing portion 82 is formed into a plate-like shape that extends in the direction orthogonal to the second optical axis O2 using metal or the like. For example, the second reinforcement fixing member 92 may be a screw or a pin that disposes the second reinforcing portion 82 and the second end portion 224 in a state of contact in the second optical axis O2 direction. In addition, the second reinforcement fixing member 92 is partially inserted into holes formed in the second reinforcing portion 82 and the second end portion 224. As a result, the second reinforcement fixing member 92 fixes the second base portion 222 and the second reinforcing portion 82.

For example, the second board fixing member 52 may be a screw or a pin that disposes the second board 32 and the second reinforcing portion 82 in a state of contact in the second optical axis O2 direction. In addition, the second board fixing member 52 is partially inserted into holes formed in the second board 32 and the second reinforcing portion 82. As a result, the second board fixing member 52 fixes the second reinforcing portion 82 and the second board 32. Consequently, fixing of the second holder 22 and the second board 32 is reinforced by the second reinforcing portion 82 and the second reinforcement fixing member 92.

The imaging apparatus 10 according to the fifth embodiment is configured as described above. Effects similar to those according to the first embodiment may also be obtained in the fifth embodiment.

### OTHER EMBODIMENTS

The present disclosure is not limited to the above-described embodiments and the above-described embodiments can be modified as appropriate. In addition, it goes without saying that an element configuring the above-described embodiments is not necessarily a requisite unless particularly specified as being a requisite, clearly considered a requisite in principle, or the like.

According to the above-described embodiments, the imaging apparatus 10 is a stereo camera having two cameras. In this regard, a quantity of cameras in the imaging apparatus 10 is not limited to two. The imaging apparatus 10 may have a single camera or three or more cameras.

According to the above-described embodiments, the imaging apparatus 10 is used in a vehicle. In this regard, the imaging apparatus 10 is not limited to use in a vehicle and may, for example, be used in a facility.

The above-described embodiments may be combined as appropriate.

### Aspects of the Present Disclosure

### First Aspect

An imaging apparatus, including: a lens (11); a holder (21) that includes a housing portion (210) that houses the lens, and a base portion (212) that is connected to the housing portion and extends in a direction orthogonal to an optical axis (O1) of the lens; an image sensor (41) that outputs a signal corresponding to a captured image based on light passing through the lens; a housing (60) that houses the base portion and the image sensor; and a fixing member (71) that disposes the base portion and the housing in a state of contact in a direction of the optical axis, and fixes the base portion and the housing, in which the fixing member includes a head portion (710) that sandwiches the housing together with the base portion, a coefficient of linear expansion of the housing and a coefficient of linear expansion of the fixing member differ, and a length (Lb1) in a direction of the optical axis from a portion of the base portion in contact with the housing to an end portion (214) on a side opposite the portion in contact with the housing is longer than a length (Lh1) in the direction of the optical axis from a portion of the housing in contact with the head portion to a portion in contact with the base portion.

### Second Aspect

The imaging apparatus according to the first aspect, in which: the holder and the housing a formed of a same material.

### Third Aspect

The imaging apparatus according to the first aspect, in which: the lens is a first lens; the housing portion is a first housing portion; the base portion is a first base portion; the holder is a first holder; the image sensor is a first image sensor; the fixing member is a first fixing member; the head portion is a first head portion; the imaging apparatus includes a second lens (12), a second image sensor (42) that outputs a signal corresponding to a captured image based on light passing through the second lens, a second holder (22) that includes a second housing portion (220) that houses the second lens, and a second base portion (222) that is connected to the second housing portion and extends in a direction orthogonal to the optical axis, and a second fixing member (73) that disposes the second base portion and the housing in a state of contact in the direction of the optical axis, and fixes the second base portion and the housing; the second fixing member includes a second head portion (720) that sandwiches the housing together with the second base portion; the housing houses the first base portion, the first image sensor, the second base portion, and the second image sensor; the coefficient of linear expansion of the housing and the coefficient of linear expansion of the second fixing member differ; and a length (Lb2) in a direction of the optical axis from a portion of the second base portion in contact with the housing to an end portion (224) on a side opposite the portion in contact with the housing is longer than a length (Lh2) in the direction of the optical axis from a portion of the housing in contact with the second head portion to a portion in contact with the second base portion.

### Fourth Aspect

The imaging apparatus according to the third aspect, in which: the housing includes a first contact portion (611) that is in contact with the first base portion in the direction orthogonal to the optical axis, and a second contact portion (622) that is in contact with the second base portion in the direction orthogonal to the optical axis; and a direction of force acting on the first base portion from the first contact portion and a direction of force acting on the second base portion from the second contact portion is a same direction.

### Fifth Aspect

The imaging apparatus according to the third or fourth aspect, in which: the first holder, the second holder, and the housing are formed of a same material.

### Sixth Aspect

The imaging apparatus according to any one of the third to fifth aspects, in which: the first lens and the second lens are arrayed in the direction orthogonal to the optical axis; the imaging apparatus includes a third fixing member (72) that disposes the first base portion and the housing in a state of contact in the direction of the optical axis, and fixes the first base portion and the housing, and a fourth fixing member (74) that disposes the second base portion and the housing in a state of contact in the direction of the optical axis, and fixes the second base portion and the housing; when the direction in which the first lens and the second lens are arrayed is a parallel direction (Dp), the optical axis is a first optical axis, a straight line passing through the first optical axis and extending in the parallel direction is a first straight line (I1), the optical axis of the second lens is a second optical axis (O2), and a straight line passing through the second optical axis and extending in the parallel direction is a second straight line (I2), the first fixing member is disposed further toward one side in a direction orthogonal to a direction of the first optical axis and the parallel direction than the first straight line is, the second fixing member is disposed further toward one side in a direction orthogonal to a direction of the second optical axis and the parallel direction than the second straight line is, the third fixing member is disposed further toward another side in the direction orthogonal to the direction of the first optical axis and the parallel direction than the first straight line is, and the fourth fixing member is disposed further toward another side in the direction orthogonal to the direction of the second optical axis and the parallel direction than the second straight line is.

### Seventh Aspect

The imaging apparatus according to the sixth aspect, further including: a fifth fixing member (75) that fixes the first base portion and the housing; and a sixth fixing member (76) that fixes the second base portion and the housing; in which: a plane is formed by line segments connecting the first fixing member, the third fixing member, and the fifth fixing member; and a plane is formed by line segments connecting the second fixing member, the fourth fixing member, and the sixth fixing member.

### Eighth Aspect

The imaging apparatus according to the first or second aspect, in which: the fixing member is a first fixing member; the imaging apparatus includes a second fixing member (72) that disposes the base portion and the housing in a state of contact in the direction of the optical axis, and fixes the base portion and the housing, and a third fixing member (73) that fixes the base portion and the housing; and a plane is formed by line segments connecting the first fixing member, the second fixing member and the third fixing member.

What is claimed is:

1. An imaging apparatus, comprising:
a lens;
a holder that includes a housing portion that houses the lens, and a base portion that is connected to the housing portion and extends in a direction orthogonal to an optical axis of the lens;
an image sensor that outputs a signal corresponding to a captured image based on light passing through the lens;
a housing that houses the base portion and the image sensor; and
a fixing member that disposes the base portion and the housing in a state of contact in a direction of the optical axis, and fixes the base portion and the housing, wherein
the fixing member includes a head portion that sandwiches the housing together with the base portion,
a coefficient of linear expansion of the housing and a coefficient of linear expansion of the fixing member differ, and
a length in a direction of the optical axis from a portion of the base portion in contact with the housing to an end portion on a side opposite the portion in contact with the housing is longer than a length in the direction of the optical axis from a portion of the housing in contact with the head portion to a portion in contact with the base portion.

2. The imaging apparatus according to claim 1, wherein:
the holder and the housing a formed of a same material.

3. The imaging apparatus according to claim 1, wherein:
the lens is a first lens;
the housing portion is a first housing portion;
the base portion is a first base portion;
the holder is a first holder;
the image sensor is a first image sensor;
the fixing member is a first fixing member;
the head portion is a first head portion;
the imaging apparatus includes
a second lens,
a second image sensor that outputs a signal corresponding to a captured image based on light passing through the second lens,
a second holder that includes a second housing portion that houses the second lens, and a second base portion that is connected to the second housing portion and extends in a direction orthogonal to the optical axis, and
a second fixing member that disposes the second base portion and the housing in a state of contact in the direction of the optical axis, and fixes the second base portion and the housing;
the second fixing member includes a second head portion that sandwiches the housing together with the second base portion;
the housing houses the first base portion, the first image sensor, the second base portion, and the second image sensor;
the coefficient of linear expansion of the housing and the coefficient of linear expansion of the second fixing member differ; and
a length in a direction of the optical axis from a portion of the second base portion in contact with the housing to an end portion on a side opposite the portion in contact with the housing is longer than a length in the direction of the optical axis from a portion of the housing in contact with the second head portion to a portion in contact with the second base portion.

4. The imaging apparatus according to claim 3, wherein:
the housing includes
a first contact portion that is in contact with the first base portion in the direction orthogonal to the optical axis, and
a second contact portion that is in contact with the second base portion in the direction orthogonal to the optical axis; and
a direction of force acting on the first base portion from the first contact portion and a direction of force acting on the second base portion from the second contact portion is a same direction.

5. The imaging apparatus according to claim 3, wherein:
the first holder, the second holder, and the housing are formed of a same material.

6. The imaging apparatus according to claim 3, wherein:
the first lens and the second lens are arrayed in the direction orthogonal to the optical axis;
the imaging apparatus includes
a third fixing member that disposes the first base portion and the housing in a state of contact in the direction of the optical axis, and fixes the first base portion and the housing, and
a fourth fixing member that disposes the second base portion and the housing in a state of contact in the direction of the optical axis, and fixes the second base portion and the housing;
when the direction in which the first lens and the second lens are arrayed is a parallel direction,
the optical axis is a first optical axis,
a straight line passing through the first optical axis and extending in the parallel direction is a first straight line,
the optical axis of the second lens is a second optical axis, and
a straight line passing through the second optical axis and extending in the parallel direction is a second straight line,
the first fixing member is disposed further toward one side in a direction orthogonal to a direction of the first optical axis and the parallel direction than the first straight line is,
the second fixing member is disposed further toward one side in a direction orthogonal to a direction of the second optical axis and the parallel direction than the second straight line is,
the third fixing member is disposed further toward another side in the direction orthogonal to the direction of the first optical axis and the parallel direction than the first straight line is, and
the fourth fixing member is disposed further toward another side in the direction orthogonal to the direction of the second optical axis and the parallel direction than the second straight line is.

7. The imaging apparatus according to claim 6, further comprising:
a fifth fixing member that fixes the first base portion and the housing; and
a sixth fixing member that fixes the second base portion and the housing; wherein
a plane is formed by line segments connecting the first fixing member, the third fixing member, and the fifth fixing member; and
a plane is formed by line segments connecting the second fixing member, the fourth fixing member, and the sixth fixing member.

8. The imaging apparatus according to claim 1, wherein:
the fixing member is a first fixing member;
the imaging apparatus includes
a second fixing member that disposes the base portion and the housing in a state of contact in the direction of the optical axis, and fixes the base portion and the housing, and
a third fixing member that fixes the base portion and the housing; and
a plane is formed by line segments connecting the first fixing member, the second fixing member and the third fixing member.

9. The imaging apparatus according to claim 4, wherein:
the first holder, the second holder, and the housing are formed of a same material.

10. The imaging apparatus according to claim 4, wherein:
the first lens and the second lens are arrayed in the direction orthogonal to the optical axis;
the imaging apparatus includes
a third fixing member that disposes the first base portion and the housing in a state of contact in the direction of the optical axis, and fixes the first base portion and the housing, and
a fourth fixing member that disposes the second base portion and the housing in a state of contact in the direction of the optical axis, and fixes the second base portion and the housing;
when the direction in which the first lens and the second lens are arrayed is a parallel direction,
the optical axis is a first optical axis,
a straight line passing through the first optical axis and extending in the parallel direction is a first straight line,
the optical axis of the second lens is a second optical axis, and
a straight line passing through the second optical axis and extending in the parallel direction is a second straight line,
the first fixing member is disposed further toward one side in a direction orthogonal to a direction of the first optical axis and the parallel direction than the first straight line is,
the second fixing member is disposed further toward one side in a direction orthogonal to a direction of the second optical axis and the parallel direction than the second straight line is,
the third fixing member is disposed further toward another side in the direction orthogonal to the direction of the first optical axis and the parallel direction than the first straight line is, and
the fourth fixing member is disposed further toward another side in the direction orthogonal to the direction of the second optical axis and the parallel direction than the second straight line is.

11. The imaging apparatus according to claim 2, wherein:
the fixing member is a first fixing member;
the imaging apparatus includes
a second fixing member that disposes the base portion and the housing in a state of contact in the direction of the optical axis, and fixes the base portion and the housing, and
a third fixing member that fixes the base portion and the housing; and
a plane is formed by line segments connecting the first fixing member, the second fixing member and the third fixing member.
